(19) United States
(12) Patent Application Publication
(10) Pub. No.: US 2024/0227705 A1
(43) Pub. Date: Jul. 11, 2024

(54) VEHICULAR PERSONAL ELECTRONIC DEVICE CHARGING SYSTEM

(71) Applicant: Ramon Castaneda, Tujunga, CA (US)

(72) Inventor: Ramon Castaneda, Tujunga, CA (US)

(21) Appl. No.: 18/095,846

(22) Filed: Jan. 11, 2023

(51) Int. Cl. B60R 16/03; H02J 7/00; H02J 50/10

(52) U.S. Cl. CPC B60R 16/03; H02J 7/0042; H02J 50/10

(57) ABSTRACT

A vehicular personal electronic device charging system for storing a personal electronic device in a vehicle includes a personal electronic device including a battery being positioned within the personal electronic device. A tray has a top side and a bottom side. The top side removably abuts the personal electronic device. The tray includes a base wall having a perimeter edge and a perimeter wall is coupled to the perimeter edge and extends upwardly from the base wall. A battery charger is coupled to the tray and is electrically engageable with the personal electronic device, wherein the battery charger provides electricity to the battery when the electronic device is abutting the base wall. A fastener is coupled to the tray and is removably fastened to a surface of an interior of a vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to battery chargers and more particularly pertains to a new battery charger for storing a personal electronic device in a vehicle.

### (2) Description of Related Art Including Information Disclosed Under 37 CFR 1.97 and 1.98

The prior art relates to battery chargers and includes a variety of battery charges being configured to provide electricity to a battery of a personal electronic device. Known prior art does not include a portable battery charger, including a tray to removably store the personal electronic device within a vehicle in a stable configuration.

### BRIEF SUMMARY OF THE INVENTION

An embodiment of the disclosure meets the needs presented above by generally comprising a personal electronic device including a battery being positioned within the personal electronic device. The battery is rechargeable. A tray has a top side and a bottom side. The top side removably abuts the personal electronic device. The tray includes a base wall having a perimeter edge and a perimeter wall is coupled to the perimeter edge and extends upwardly from the base wall. A battery charger is coupled to the tray and is electrically engageable with the personal electronic device, wherein the battery charger provides electricity to the battery when the electronic device is abutting the base wall. A fastener is coupled to the tray and is configured to be removably fastened to a surface of an interior of a vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a vehicular personal electronic device charging system according to an embodiment of the disclosure.

FIG. 2 is a top perspective view of an embodiment of the disclosure.

FIG. 3 is a bottom perspective view of an embodiment of the disclosure.

FIG. 4 is a cross-sectional view of an embodiment of the disclosure taken along Line 4-4 of FIG. 1.

FIG. 5 is a top view of an embodiment of the disclosure.

FIG. 6 is a bottom view of an embodiment of the disclosure.

FIG. 7 is an in-use view of an embodiment of the disclosure.

FIG. 8 is an in-use view of an embodiment of the disclosure.

FIG. 9 is a box diagram of an embodiment of the disclosure.

### DETAILED DESCRIPTION OF THE INVENTION

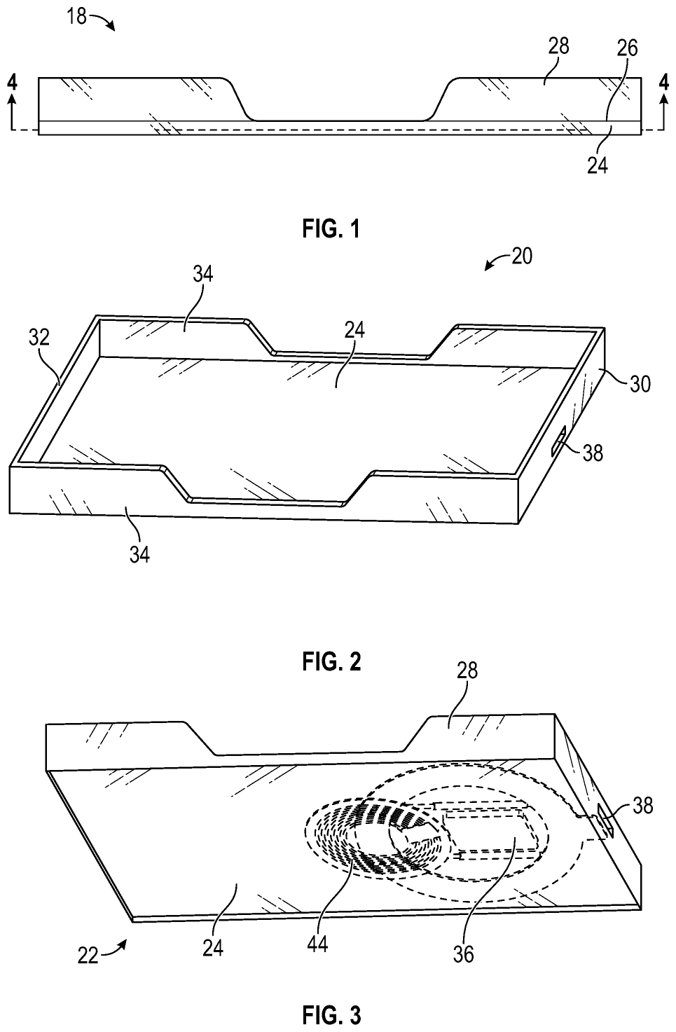

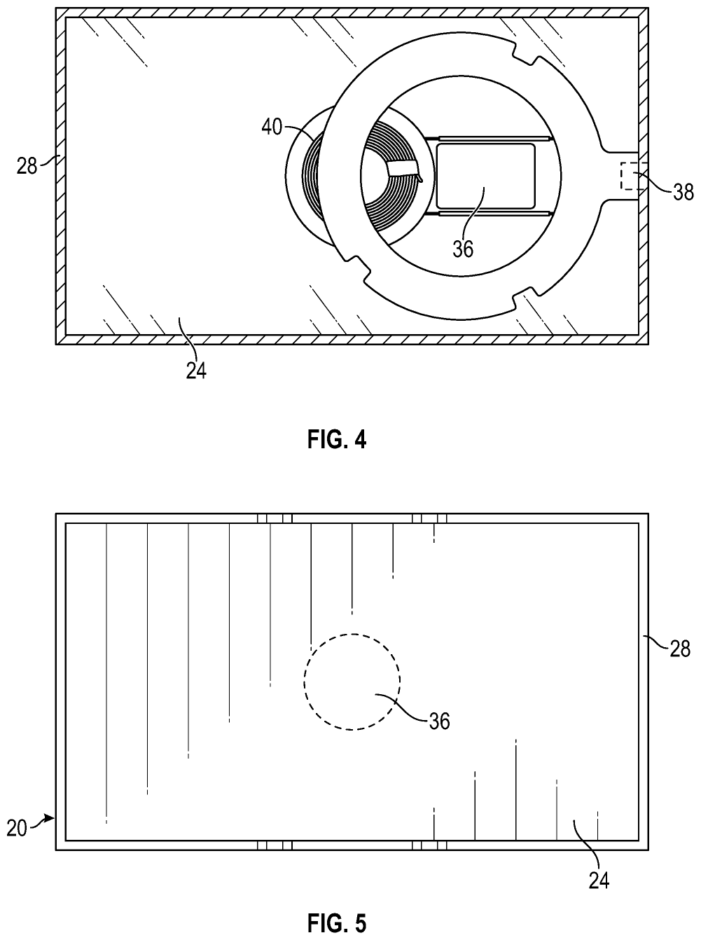

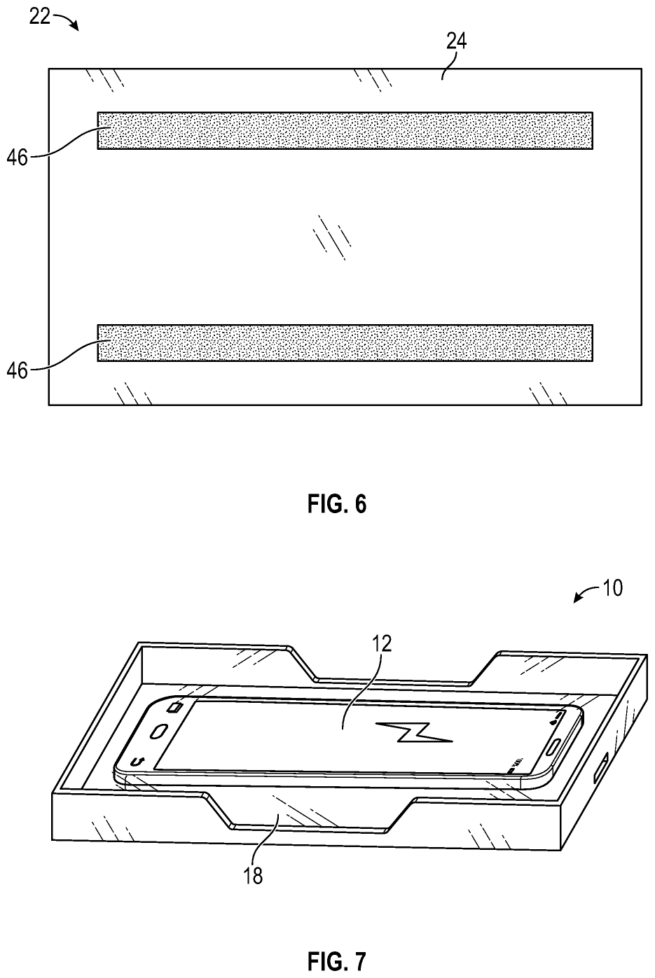

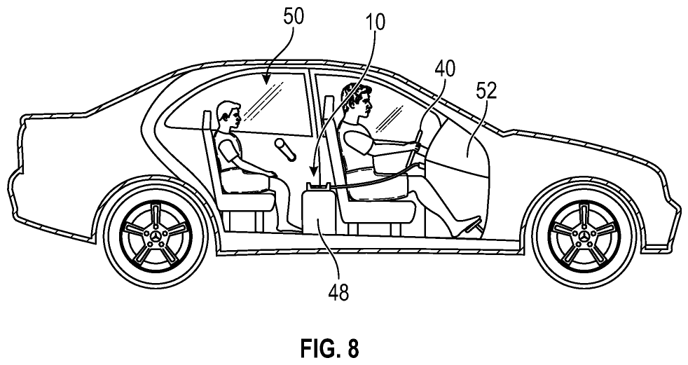

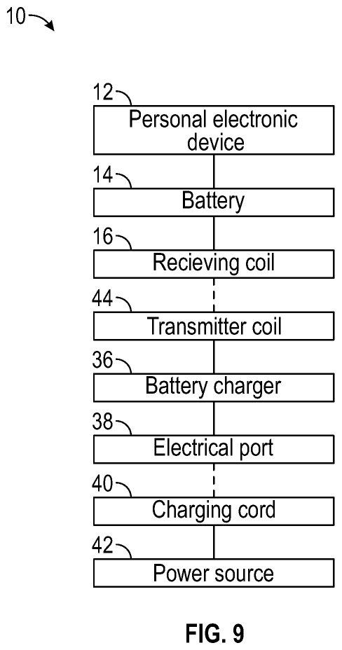

With reference now to the drawings, and in particular to FIGS. 1 through 9 thereof, a new battery charger embodying the principles and concepts of an embodiment of the disclosure and generally designated by the reference numeral 10 will be described.

As best illustrated in FIGS. 1 through 9, the vehicular personal electronic device charging system 10 generally comprises a personal electronic device 12 such as a mobile phone, a computer tablet, or any other conventional personal electronic device 12. The personal electronic device 12 typically includes a battery 14 being positioned within the personal electronic device 12 and is normally rechargeable. A receiver coil 16 is electrically coupled to the battery 14 and is capable of receiving electricity by electromagnetic induction. The receiver coil 16 is typically positioned within the personal electronic device 12.

A tray 18 has a top side 20 and a bottom side 22 and the top side 20 removably abuts the personal electronic device 12. The tray 18 includes a base wall 24 having a perimeter edge 26 and a perimeter wall 28 is coupled to the perimeter edge 26 and extends upwardly from the base wall 24. The perimeter wall 28 may include a first wall 30, a second wall 32, and a pair of lateral walls 34. Each lateral wall 34 of the pair of lateral walls 34 is elongated to form the tray 18 into a rectangular shape. The perimeter wall 28 is typically coextensive with the perimeter edge 26. A cutout may be positioned on and extending through the perimeter wall 28, wherein the cutout facilitates grabbing the personal electronic device 12 from the top side 20.

A battery charger 36 is coupled to the tray 18 and is electrically engageable with the personal electronic device 12, wherein the battery charger 36 provides electricity to the battery 14 when the electronic device is abutting the base wall 24. The battery charger typically includes an electrical port 38 for removably receiving a plug of a charging cord 40 from a power source 42. The power source 42 may comprise a vehicle battery positioned within a vehicle. The port may be positioned on the first wall 30 of the tray 18.

A transmitter coil 44 is electrically coupled to the electrical port 38. The transmitter coil 44 is in electrical communication with the receiver coil 16 by electromagnetic induction to provide electricity to the receiver coil 16 when the transmitter coil 44 is positioned proximate to the receiver coil 16. The transmitter coil 44 is typically positioned within the base wall 24, wherein the receiver coil 16 is positioned proximate to the transmitter coil 44 when the personal electronic device 12 is abutting the top side 20 of the tray 18.

A fastener 46 is coupled to the tray 18 and is configured to be removably fastened to a surface 48 of an interior 50 of the vehicle 52. The fastener 46 is coupled to the bottom side 22 of the tray 18 and typically comprises at least one adhesive strip. The fastener 46 may have two adhesive strips to facilitate fastening the tray 18 to the surface 48 of the interior 50 of the vehicle 52.

In use, the bottom side 22 of the tray 18 is fastened to the surface 48 of the interior 50 of the vehicle 52. The electrical port 38 receives the plug from the charging cord 40 of the power source 42 to provide electricity to the battery charger 36. The personal electronic device 12 abuts the top side 20 of the tray 18 and is stored between the perimeter wall 28 of the tray 18. The receiver coil 16 of the personal electronic device 12 is positioned proximate to the transmitter coil 44 of the tray 18, wherein the battery 14 of the personal electronic device 12 receives electricity from the transmitter coil 44 by electromagnetic induction.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicular device charging system comprising:
a personal electronic device including a battery being positioned within said personal electronic device, said battery being rechargeable;
a tray having a top side and a bottom side, said top side removably abutting said personal electronic device, said tray including a base wall having a perimeter edge, a perimeter wall being coupled to said perimeter edge and extending upwardly from said base wall;
a battery charger being coupled to said tray and being electrically engageable with said personal electronic device, wherein said battery charger provides electricity to said battery when said electronic device is abutting said base wall; and
a fastener being coupled to said tray and being configured to be removably fastened to a surface of an interior of a vehicle.

2. The vehicular device charging system of claim 1, further including a receiver coil being electrically coupled to said battery, said receiver coil being capable of receiving electricity by electromagnetic induction, said receiver coil being positioned within said personal electronic device.

3. The vehicular device charging system of claim 2, wherein said perimeter wall includes a first wall, a second wall, and a pair of lateral walls, each lateral wall of said pair of lateral walls being elongated, said perimeter wall being coextensive with said perimeter edge.

4. The vehicular device charging system of claim 3, wherein said battery charger includes an electrical port for removably receiving a plug of a charging cord from a power source, said port being positioned on said first wall of said tray.

5. The vehicular device charging system of claim 4, further including a transmitter coil being electrically coupled to said electrical port, said transmitter coil being in electrical communication with said receiver coil by electromagnetic induction to provide electricity to said receiver coil when said transmitter coil is positioned proximate to said receiver coil, said transmitter coil being positioned within said base wall.

6. The vehicular device charging system of claim 1, wherein said fastener is coupled to said bottom side of said tray, said fastener comprising at least one adhesive strip.

7. A vehicular device charging system comprising:
a personal electronic device including:
a battery being positioned within said personal electronic device, said battery being rechargeable; and
a receiver coil being electrically coupled to said battery, said receiver coil being capable of receiving electricity by electromagnetic induction, said receiver coil being positioned within said personal electronic device;
a tray having a top side and a bottom side, said top side removably abutting said personal electronic device, said tray including a base wall having a perimeter edge, a perimeter wall being coupled to said perimeter edge and extending upwardly from said base wall, said perimeter wall including a first wall, a second wall, and a pair of lateral walls, each lateral wall of said pair of lateral walls being elongated, said perimeter wall being coextensive with said perimeter edge;
a battery charger being coupled to said tray and being electrically engageable with said personal electronic device, wherein said battery charger provides electricity to said battery when said electronic device is abutting said base wall, said battery charger including:
an electrical port for removably receiving a plug of a charging cord from a power source, said port being positioned on said first wall of said tray; and
a transmitter coil being electrically coupled to said electrical port, said transmitter coil being in electrical communication with said receiver coil by electromagnetic induction to provide electricity to said receiver coil when said transmitter coil is positioned proximate to said receiver coil, said transmitter coil being positioned within said base wall;
a fastener being coupled to said tray and being configured to be removably fastened to a surface of an interior of a vehicle, said fastener being coupled to said bottom side of said tray, said fastener comprising at least one adhesive strip.
